(19) United States
(12) Patent Application Publication
(10) Pub. No.: US 2013/0250333 A1
(43) Pub. Date: Sep. 26, 2013

(54) IMAGE PROCESSING APPARATUS AND COMMUNICATION CONTROL METHOD

(71) Applicant: Norihisa MATSUDA, Kanagawa (JP)

(72) Inventor: Norihisa MATSUDA, Kanagawa (JP)

(73) Assignee: Ricoh Company, Limited, Tokyo (JP)

(21) Appl. No.: 13/845,748

(22) Filed: Mar. 18, 2013

(30) Foreign Application Priority Data
Mar. 22, 2012 (JP) 2012-066341

(51) Int. Cl. H04N 1/00

(52) U.S. Cl. CPC H04N 1/00893
USPC 358/1.13

(57) ABSTRACT

An image processing apparatus includes a communication unit configured to transmit and receive image data; an output unit configured to output the image data received by the communication unit; a storage battery unit used as a power source to back up the image data stored in a storage unit; a detecting unit configured to detect whether power supply from a main power source is cut off; and a power-supply control unit configured to perform a control operation that supplies power to the communication unit from the storage battery unit in a cutoff state where the detecting unit detects that the power supply is cut off. The communication unit performs, in the cutoff state, an image-data communication operation that consumes less power than a communication operation in a normal state where the detecting unit detects that the power supply is not cut off.

### CROSS-REFERENCE TO RELATED APPLICATION

The present application claims priority to and incorporates by reference the entire contents of Japanese Patent Application No. 2012-066341 filed in Japan on Mar. 22, 2012.

### BACKGROUND OF THE INVENTION

1. Field of the Invention

The present invention generally relates to an image processing apparatus and a communication control method.

2. Description of the Related Art

There have been developed a large number of image processing apparatuses such as multifunction peripherals (MFPs) that include, in addition to a copy function unit, a facsimile (fax) function unit that transmits and receives images over a public line and a printer function unit that forms an image on a recording medium according to image data received from a personal computer in recent years.

When main power supply to this type of image processing apparatus is cut off by power failure, all functions of the apparatus halt, and not only the copy function unit and the printer function unit but also an image-data communication operation by the fax function unit generally become disabled.

There are known image processing apparatuses that include a storage battery unit that supplies power source to make a fax function available even during power failure so that external communication capability is maintained even during power failure (see Japanese Patent Applications Laid-open 2008-185707 and H10-233867, for example).

However, a considerable amount of electric power is required to use the fax function during power failure. Accordingly, to make the facsimile function of such a conventional image processing apparatus available even during power failure, it is necessary to add a relatively-large storage battery unit such as a (uninterruptible power supply (UPS) or a secondary battery to the apparatus. This disadvantageously results in an increase in manufacturing cost.

Therefore, there is a need to provide an image processing apparatus capable of performing an image-data communication operation during power failure by using a storage battery unit that is already included in the apparatus, and a communication control method.

### SUMMARY OF THE INVENTION

It is an object of the present invention to at least partially solve the problems in the conventional technology.

According to an embodiment, there is provided an image processing apparatus that includes a communication unit configured to transmit and receive image data; an output unit configured to output the image data received by the communication unit; a storage battery unit used as a power source to back up the image data stored in a storage unit; a detecting unit configured to detect whether power supply from a main power source from to the image processing apparatus is cut off; and a power-supply control unit configured to perform a control operation that supplies electric power to the communication unit from the storage battery unit in a cutoff state where the detecting unit detects that the power supply from the main power supply is cut off. The communication unit performs, in the cutoff state, an image-data communication operation that consumes less power than a communication operation in a normal state where the detecting unit detects that the power supply from the main power supply is not cut off.

According to another embodiment, there is provided a communication control method performed in an image processing apparatus that includes a communication unit configured to transmit and receive image data, an output unit configured to output the image data received by the communication unit, a storage battery unit used as a power source to back up the image data stored in a storage unit, a detecting unit configured to detect whether power supply from a main power source from to the image processing apparatus is cut off, and a power-supply control unit configured to perform a control operation that supplies electric power to the communication unit from the storage battery unit in a cutoff state where the detecting unit detects that the power supply from the main power supply is cut off. The communication control method includes performing, by the communication unit performs, in the cutoff state, an image-data communication operation that consumes less power than a communication operation in a normal state where the detecting unit detects that the power supply from the main power supply is not cut off.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a hardware configuration of an image processing apparatus according to a first embodiment of the present invention;

FIG. 2 is a diagram for detailed description of a configuration of a network control unit (NCU);

FIG. 3 is a block diagram for detailed description of a configuration of a charging unit and a power-supply control unit;

FIG. 4 is a flowchart illustrating a processing sequence for transition to a power failure mode;

FIG. 5 is a flowchart illustrating processing to be performed by the image processing apparatus on detection of a startup trigger;

FIG. 6 is a flowchart illustrating processing to be performed by the image processing apparatus at recovery from power failure;

FIG. 7 is a flowchart illustrating a processing sequence to be performed by the image processing apparatus that reduces the number of types of interrupt triggers acceptable by the power-supply control unit during power failure;

FIG. 8 is a flowchart illustrating a processing sequence according to a second embodiment of the present invention;

FIG. 9 is a flowchart illustrating a processing sequence according to a third embodiment of the present invention; and

FIG. 10 is a flowchart illustrating a processing sequence according to a fourth embodiment of the present invention.

### DETAILED DESCRIPTION OF THE PREFERRED EMBODIMENTS

Preferred embodiments of the present invention are described below with reference to the accompanying drawings.

While image processing apparatuses and communication control methods according to the embodiments are applicable to any image processing apparatus, such as an MFP, having at least a function, such as a fax function, of transmitting/receiving image data, described in the following specification are examples in which the embodiments are each applied to an MFP.

An outline of a hardware configuration of an image processing apparatus 1 according to a first embodiment of the present invention is described below.

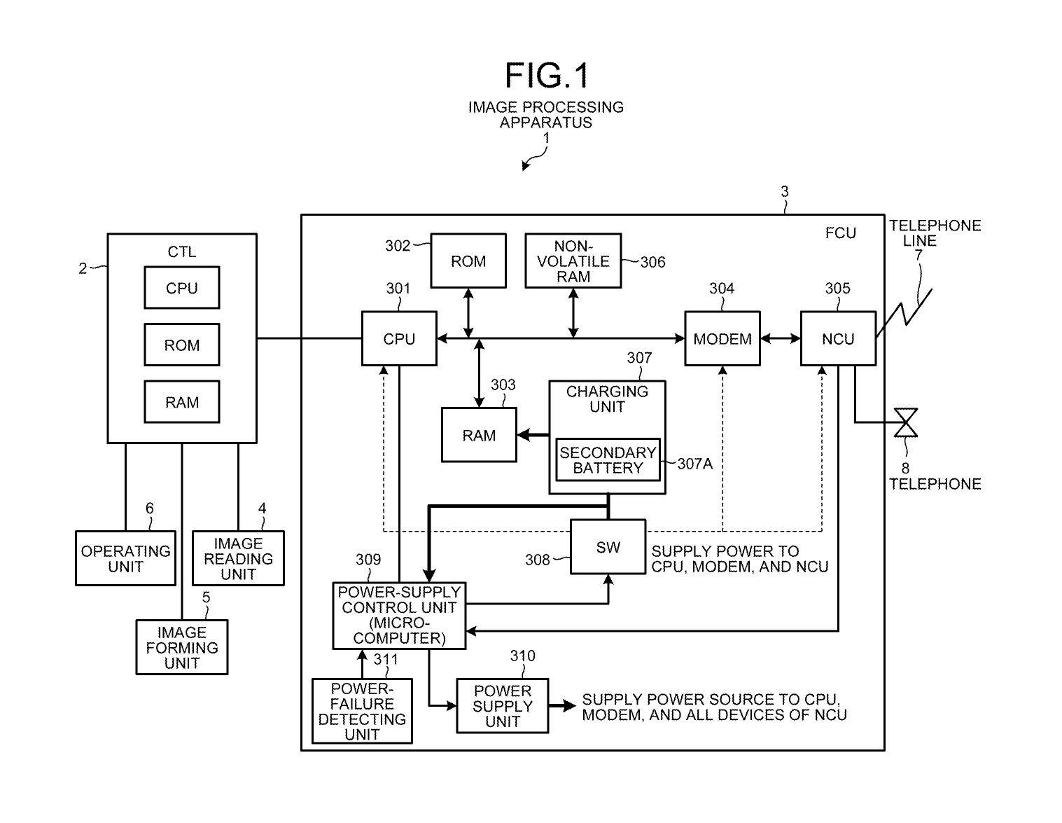

FIG. 1 is a block diagram schematically illustrating the hardware configuration of the image processing apparatus 1 according to the first embodiment. As illustrated in FIG. 1, the image processing apparatus 1 according to the first embodiment includes a controller (CTL) 2, a fax control unit (FCU) 3, an image reading unit 4, an image forming unit 5, and an operating unit 6. The FCU 3, the image reading unit 4, the image forming unit 5, and the operating unit 6, which are constituting elements of the image processing apparatus 1 excluding the CTL 2, are connected to the CTL 2.

The CTL 2 has overall control of processing of the whole image processing apparatus 1. The CTL 2 includes a central processing unit (CPU), a read only memory (ROM), and a random access memory (RAM). An engine control unit (not shown) is also connected to the CTL 2. The CTL 2 controls the image reading unit 4 and the image forming unit 5 that serve as an engine unit via the engine control unit.

The FCU 3 is a unit that performs a fax communication operation involved in the fax function. The FCU 3 according to the first embodiment includes a plurality of constituting elements (also referred to as “devices”) including a CPU 301, a ROM 302, a RAM 303, a modem 304, a network control unit (NCU) 305, a nonvolatile RAM 306, a charging unit 307, a switch (SW) 308, a power-supply control unit 309, a power supply unit 310, a power-failure detecting unit 311, and a voltage detection circuit 312.

The CPU 301 that includes a microprocessor controls processing of the whole FCU 3. Superficially, the CPU 301 executes program instructions stored in the ROM 302, thereby controlling the RAM 303, the modem 304, the NCU 305, the nonvolatile RAM 306, and the like.

The ROM 302 stores therein various data and the program instructions for use by the CPU 301. The RAM 303 is used to store data that is being processed. Specifically, the RAM 303 stores therein binary image data obtained by scanning by the image reading unit 4. The RAM 303 also stores therein binary image data which are to be output to a telephone line 7 via the NCU 305 as signals modulated by the modem 304. The RAM 303 also stores therein binary image data which are analog waveform signals input from the telephone line 7 and demodulated through the NCU 305 and the modem 304.

The modem 304 converts between analog waveform signals for the telephone line 7 and binary image data for use in the image processing apparatus 1. Specifically, the modem 304 includes a Group 3 fax (G3) modem (not shown) and a clock generating circuit (not shown) connected to the G3 modem. Under control of the CPU 301, the modem 304 generates analog waveform signals to be transmitted by modulating binary image data stored in the RAM 303, and outputs the signals to the telephone line 7 via the NCU 305. The modem 304 also causes the NCU 305 to deliver analog waveform signals fed over the telephone line 7 to the modem 304, demodulates the analog waveform signals into binary image data, and stores the image data in the RAM 303.

The NCU 305 controls connection of the image processing apparatus 1 to the telephone line 7, which is a public communication network. Specifically, the NCU 305 performs switching under control of the CPU 301, thereby connecting the telephone line 7 to any one of the modem 304 and a telephone 8. The NCU 305 includes a ringing signal detector. When a ringing signal is detected, the NCU 305 outputs an incoming call signal to the power-supply control unit 309. The telephone 8 is externally connected to the FCU 3. The telephone 8 includes, for instance, a handset, a speech network, a dialer, number keys, and a One-Touch key (none of these are shown).

The nonvolatile RAM 306 stores therein data (e.g., speed dial numbers) that needs to be stored even under a state where power supply to the FCU 3 is cut off.

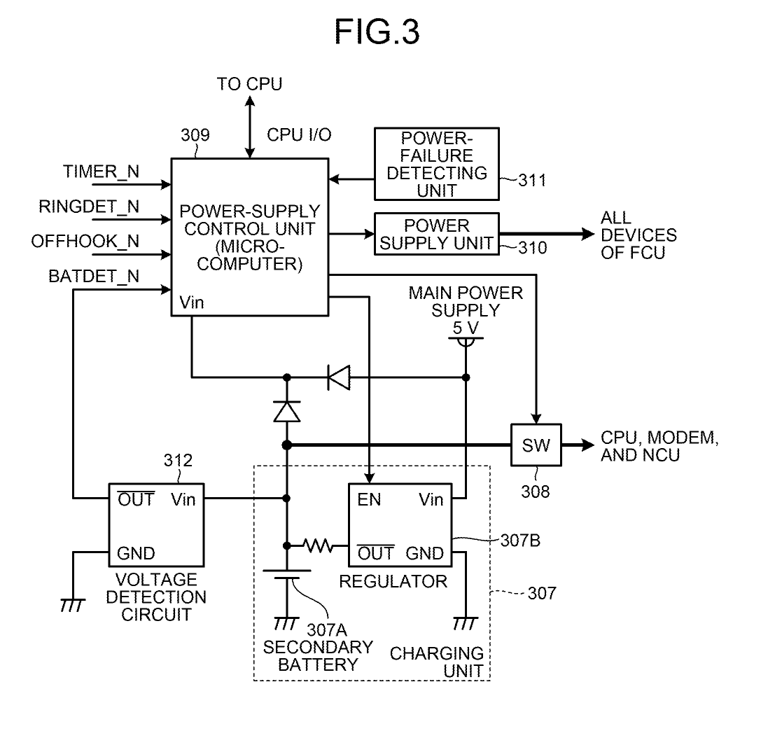

The charging unit 307 is for use as a backup power source that prevents loss of data that is being stored in a case where power supply to the image processing apparatus 1 from a commercial power source (hereinafter, also referred to as “main power supply”) is cut off while the data is being stored in the RAM 303. Specifically, the charging unit 307 includes a secondary battery (storage battery unit) 307A that stores electric power supplied from the commercial power source and a regulator (charging unit) 307B (see FIG. 3) for use in charging the secondary battery 307A.

The SW 308 is provided to switch power supply to loads of the FCU 3 between power supply from the commercial power source and power supply from the charging unit 307 serving as the backup power source.

The power-supply control unit (microcomputer) 309 controls power supply to each device of the FCU 3. The power-supply control unit 309 according to the first embodiment is connected to two power systems, or, more specifically, the commercial power source (main power supply (+5 V)) and the secondary battery 307A, via the power supply unit 310. The power-supply control unit 309 has a normal mode in which electric power is supplied to all the devices that make up the FCU 3 and a power failure mode for the cutoff state (also referred to as “power failure state”) in which the main power supply is cut off due to power failure, breaking of wire, or the like. In the power failure mode, execution of program instructions is stopped and only startup triggers as interruptions are accepted. In the normal mode, electric power is supplied to the power-supply control unit 309 from the main power supply, while, in the power failure mode, electric power is supplied to the power-supply control unit 309 from the secondary battery 307A.

The power supply unit 310 is a switching power source that controls on/off of power supply to the loads of the FCU 3. Specifically, the power supply unit 310 starts or stops power supply to the devices of the FCU 3 on a device-by-device basis according to a startup signal or a stop signal supplied from the power-supply control unit 309.

The power-failure detecting unit 311 detects whether the image processing apparatus 1 is supplied with electric power from the commercial power source.

The voltage detection circuit 312 detects a voltage of the secondary battery 307A to determine a discharge status.

The image reading unit 4 is a unit that performs an image reading operation involved in a scanner function. Specifically, the image reading unit 4 includes a direct memory access (DMA) controller, an image processing integrated circuit (IC), an image sensor, and a complementary metal oxide semiconductor (CMOS) logic IC (none of these are shown), for example. The image reading unit 4 reads an image of a document placed on an automatic document feeder (ADF) (not shown) or an exposure glass (not shown) utilizing a contact sensor (CS), converts the read data into binary date, and sequentially sends the binary data to the RAM.

The image forming unit 5 is a unit that performs an image forming operation involved in a printer function. Specifically, the image forming unit 5 includes a monochrome plotter or a color plotter, an application specific integrated circuit (ASIC), and a fixing device, for example. The image forming unit 5 performs various image processing such as error diffusion and gamma conversion on image data read by the image reading unit 4 and stored in the RAM 303, image data received from an external device such as a personal computer via a network (not shown), or image data received as a fax over the telephone line 7, and forms an image on a recording medium such as recording paper according to the image-processed image data.

The operating unit 6 receives an operating input from a user. Specifically, the operating unit 6 includes a button for starting fax transmission as image transmission, fax reception as image reception, and the like, a mode select key for selecting an operating mode(s) such as a fine mode, a standard mode, and an auto-receipt mode for fax communication, number keys for dialing, and a One-Touch key.

The configuration of the NCU 305 is described in detail below.

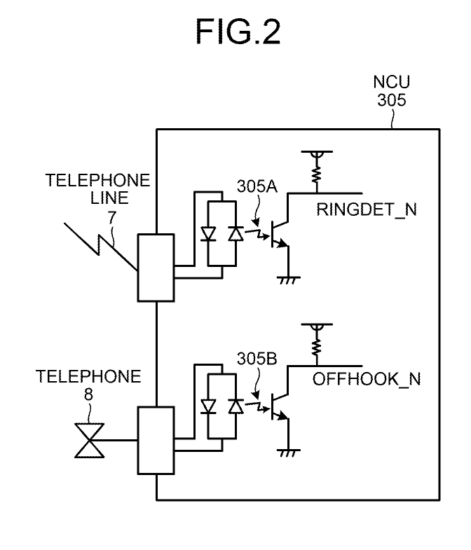

FIG. 2 is a diagram for detailed description of the configuration of the NCU 305. As illustrated in FIG. 2, the NCU 305 includes a photocoupler 305A and a photocoupler 305B.

The photocoupler 305A is provided to detect a ringing signal. The photocoupler 305A operates in such a manner that when the photocoupler 305A receives a ringing signal over the telephone line 7, an input of low level (an incoming call signal) RINGDET_N is fed to the power-supply control unit 309.

The photocoupler 305B is provided to detect off-hook. The photocoupler 305B operates in such a manner that when the telephone 8 is off hook, an input of low level OFFHOOK_N is fed to the power-supply control unit 309.

The configuration of the charging unit 307 and the power-supply control unit 309 is described in detail below.

FIG. 3 is a block diagram for detailed description of the configuration of the charging unit 307 and the power-supply control unit 309. As illustrated in FIG. 3, the charging unit 307 includes the secondary battery 307A and the regulator 307B. The charging unit 307 charges the secondary battery 307A utilizing the regulator 307B. Specifically, when performing charging, the charging unit 307 causes the regulator 307B to output by pulling EN pin to high. With this configuration, because the EN pin is pulled high only during charging, unnecessary power consumption can be reduced.

As illustrated in FIG. 3, the power-supply control unit 309 includes input pins including RINGDET_N, OFFHOOK_N, and TIMER_N for detecting various startup triggers for use in fax communication. The power-supply control unit 309 is capable of exchanging data to and from the CPU 301 via a serial interface input/output (I/O) and sends a notification to the CPU 301 about a startup trigger and a power supply state (a signal indicating whether electric power is supplied from the commercial power source) at startup. Accordingly, the CPU 301 changes startup control of the FCU 3 according to information sent from the power-supply control unit 309 as the notification.

Meanwhile, RINGDET_N goes low when a ringing signal is received. OFFHOOK_N goes low when the externally connected telephone 8 becomes off hook. TIMER_N goes low when preset time for fax transmission comes. The power-supply control unit 309 obtains information indicating current time from a real time clock (RTC) (not shown).

The power-supply control unit 309 also includes an input pin for detecting BATDET_N. Meanwhile, BATDET_N goes high when an output voltage of the secondary battery 307A detected by the voltage detection circuit 312 is higher than a predetermined voltage, while BATDET_N goes low when the detected output voltage of the secondary battery 307A is lower than the predetermined voltage.

Processing to be performed by the image processing apparatus 1 according to the first embodiment is described below.

First, a processing sequence to be performed by the image processing apparatus 1 for transition to the power failure mode is described below.

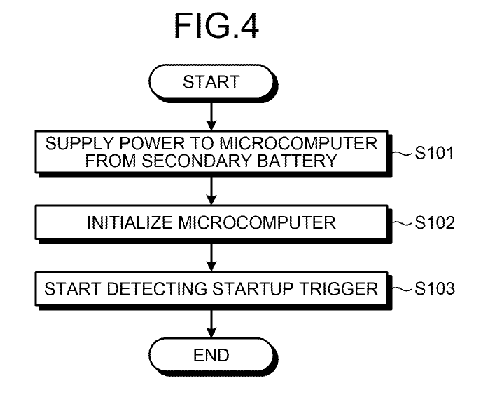

FIG. 4 is a flowchart illustrating the processing sequence for the transition to the power failure mode. As illustrated in FIG. 4, in the image processing apparatus 1, when electric power is supplied to the power-supply control unit 309 from the secondary battery 307A (Step S101) because the commercial power source is cut off due to power failure, wire breakage, or the like, initialization of the power-supply control unit 309 is performed (Step S102). After completion of the initialization, the power-supply control circuit 309 of the image processing apparatus 1 starts detecting interruption triggered by a startup trigger such as RINGDET_N (Step S103).

Next, processing to be performed by the image processing apparatus 1 on detection of a startup trigger is described below.

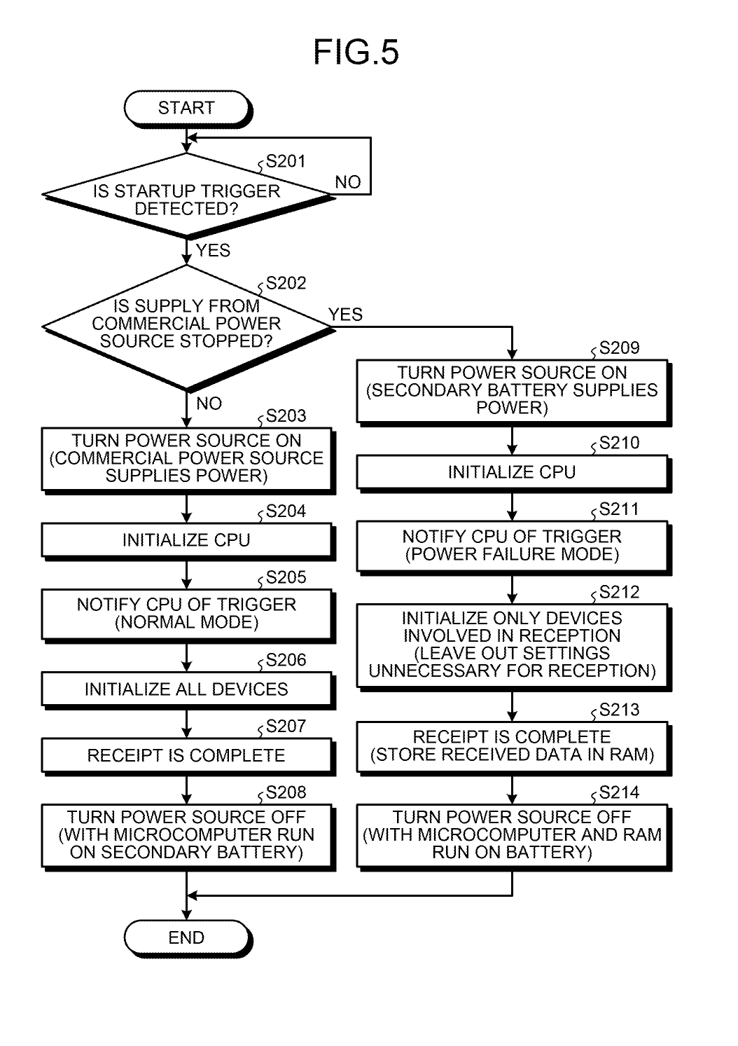

FIG. 5 is a flowchart illustrating processing to be performed by the image processing apparatus 1 on detection of a startup trigger. FIG. 5 illustrates an example processing sequence for a case in which RINGDET_N for fax reception is detected as the startup trigger.

As illustrated in FIG. 5, in the image processing apparatus 1, when RINGDET_N is detected as the startup trigger (Yes at Step S201), the power-supply control unit 309 determines whether electric power is supplied from the commercial power source or, in other words, whether the apparatus is in a cutoff state (hereinafter, also referred to as the “power failure state”) in which the commercial power source is cut off due to power failure, wire breakage, or the like based on a notification sent from the power-failure detecting unit 311 (Step S202).

When it is determined that the apparatus is not in the power failure state (No at Step S202), the power-supply control unit 309 controls the power supply unit 310 to cause all the devices that make up the FCU 3 to be supplied with electric power from the commercial power source, thereby starting up the FCU 3 in a normal manner (Step S203).

Thereafter, the CPU 301 is initialized in the FCU 3 (Step S204). Subsequently, the power-supply control unit 309 sends to the CPU 301 a notification about the startup trigger and a power supply state (specifically, in this situation, a signal indicating that the commercial power source is supplied) (Step S205). On receiving the notification, the CPU 301 performs startup processing in the normal mode.

Subsequently, the CPU 301 initializes all the devices that make up the FCU 3 (Step S206). Thereafter, the FCU 3 completes a receiving operation through a normal startup sequence (Step S207). When image data has been received, the received image data is subjected to processing such as modulation performed by the modem 304, and stored in the RAM 303 in the FCU 3. The image processing apparatus 1 forms an image on a recording medium using the image forming unit 5 as an output task that outputs the image data stored in the RAM 303.

Thereafter, the power-supply control unit 309 cuts off (turns power off) power supply to all the devices that make up the FCU 3 (Step S208). Note that electric power is supplied to the power-supply control unit 309 from the secondary battery 307A in this state. After processing at Step S208, the image processing apparatus 1 completes the sequence.

On the other hand, when it is determined that the apparatus is in the power failure state (Yes at Step S202), the power-supply control unit 309 turns on the SW 308 and controls the power supply unit 310 to cause the secondary battery 307A to supply electric power to all the devices that make up the FCU 3 (Step S209). Accordingly, the FCU 3 starts up.

Thereafter, in the FCU 3, the CPU 301 is initialized (Step S210). Subsequently, the power-supply control unit 309 sends to the CPU 301 a notification about the startup trigger and a power supply state (in this situation, specifically, a signal indicating that the commercial power source is not supplied) (Step S211). On receiving the notification, the CPU 301 performs startup processing in the power failure mode.

Subsequently, the CPU 301 initializes only predetermined devices as minimum processing for fax reception; in other words, the CPU 301 does not configure settings that are unnecessary for fax reception (Step S212). Thereafter, when image data has been received, the received image data is subjected to processing such as modulation performed by the modem 304 and stored in the RAM 303 (Step S213).

Thereafter, in the FCU 3, the power-supply control unit 309 cuts off power supply to all the devices that make up the FCU 3 excluding the power-supply control unit 309 and the RAM 303 (Step S214).

Processing to be performed by the image processing apparatus 1 at recovery from power failure is described below.

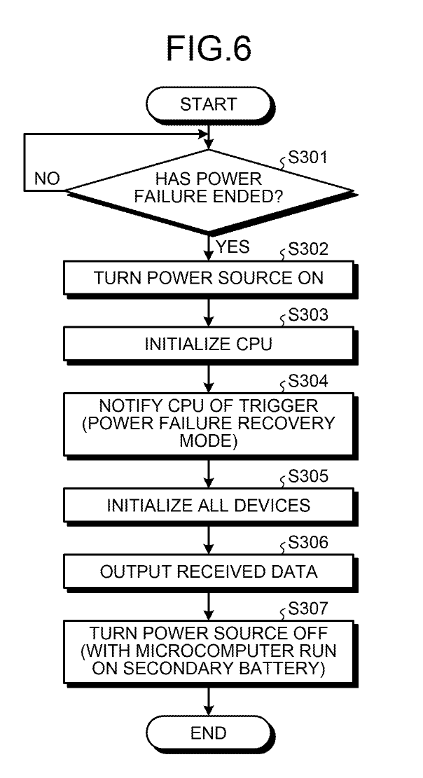

FIG. 6 is a flowchart illustrating processing to be performed by the image processing apparatus 1 at recovery from power failure. The sequence illustrated in FIG. 6 starts on a precondition that image data received in the power failure mode is stored in the RAM 303.

As illustrated in FIG. 6, in the image processing apparatus 1, when the power-supply control unit 309 determines based on a notification from the power-failure detecting unit 311 that electric power is supplied from the commercial power source or, put another way, power failure has ended (Yes at Step S301), the power-supply control unit 309 controls the power supply unit 310 to cause all the devices that make up the FCU 3 to be supplied with electric power via the commercial power source, thereby starting up the FCU 3 in the normal manner (Step S302).

Thereafter, in the FCU 3, the CPU 301 is initialized (Step S303). Subsequently, the power-supply control unit 309 sends to the CPU 301 a notification about a power supply state (in this situation, the signal indicating that the commercial power source is supplied) (Step S304). On receiving the notification, the CPU 301 performs startup processing in a power failure recovery mode.

Subsequently, the CPU 301 initializes all the devices that make up the FCU 3 (Step S305). Thereafter, the CPU 301 performs an output task that outputs the image data stored in the RAM 303 (Step S306). Accordingly, the image forming unit 5 forms an image on a recording medium according to the image data stored in the RAM 303 under control of the CTL 2.

Thereafter, the power-supply control unit 309 cuts off (turns power off) power supply from the commercial power source to all the devices that make up the FCU 3 (Step S307). Note that electric power is supplied to the power-supply control unit 309 from the secondary battery 307A in this state. After processing at Step S308, the image processing apparatus 1 completes the sequence.

With the configuration described above, the image-data output task, which is a remaining task of the fax receiving operation, is automatically performed at recovery from power failure without involvement of a user. Accordingly, such an undesirably situation that image data stored during power failure is left unprocessed or unintentionally deleted can be prevented.

Described below is processing to be performed by the image processing apparatus 1 that reduces the number of types of interrupt startup triggers acceptable by the power-supply control unit 309 in the power failure mode to a value smaller than that in the normal mode.

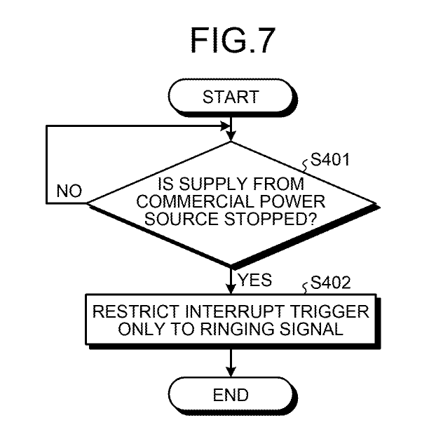

FIG. 7 is a flowchart illustrating a processing sequence to be performed by the image processing apparatus 1 that reduces the number of types of interrupt startup triggers acceptable by the power-supply control unit 309 in the power failure mode to a value smaller than that in the normal mode. As illustrated in FIG. 7, in the image processing apparatus 1, when the power-supply control unit 309 determines based on a notification sent from the power-failure detecting unit 311 that electric power is not supplied from the commercial power source or, in other words, the apparatus is in the cutoff state in which the commercial power source is cut off due to power failure, wire breakage, or the like (Yes at Step S401), subsequently, the power-supply control unit 309 enables RINGDET_N which is the interrupt startup trigger for fax reception, and disables OFFHOOK_N and TIMER_N which are interrupt startup triggers for fax transmission. Put another way, the power-supply control unit 309 restricts acceptable interrupt startup trigger only to RINGDET_N (receipt of a ringing signal) for fax reception (Step S402).

When the configuration described above is employed, it becomes possible to disable operations involved in fax transmission in the power failure mode. As a result, power consumption of the secondary battery 307A in the power failure mode can be reduced, and fax reception can be performed with a higher priority in the power failure mode.

Other embodiments of the present invention are described below.

A second embodiment of the present invention is described below.

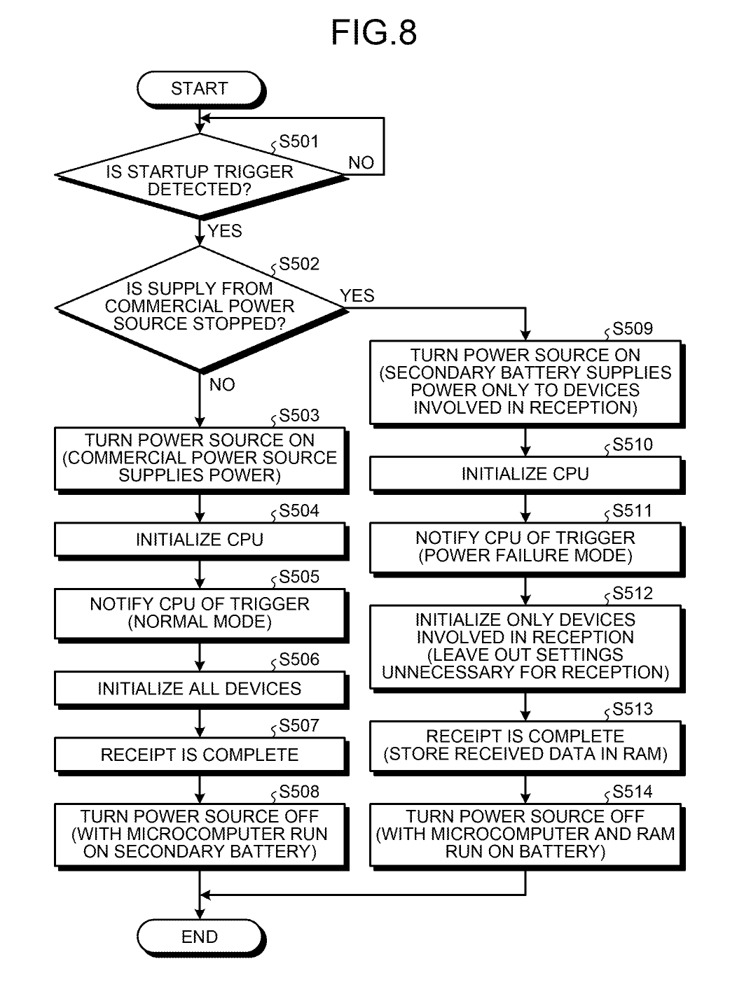

FIG. 8 is a flowchart of a processing sequence according to the second embodiment, a modification of the processing sequence according to the first embodiment illustrated in FIG. 5. Specifically, the processing sequence illustrated in FIG. 8 is obtained by modifying processing at Step S209 of the processing sequence illustrated in FIG. 5 to processing at Step S509. Only Step S509 that differs from the corresponding step of the processing sequence illustrated in FIG. 5 is described below, and description about the other identical steps is omitted.

At Step S509, the power-supply control unit 309 turns on the SW 308 and controls the power supply unit 310 to cause the secondary battery 307A to supply electric power only to predetermined devices (e.g., the CPU 301, the RAM 303, the modem 304, and the NCU 305) that are determined in advance as being involved in image data reception among the devices that make up the FCU 3, in contrast to processing at Step S209 of the processing sequence illustrated in FIG. 5.

With this configuration, because power consumption of the secondary battery 307A in the power failure mode can be reduced, the power failure mode can be maintained for a longer period of time.

A third embodiment of the present invention is described below.

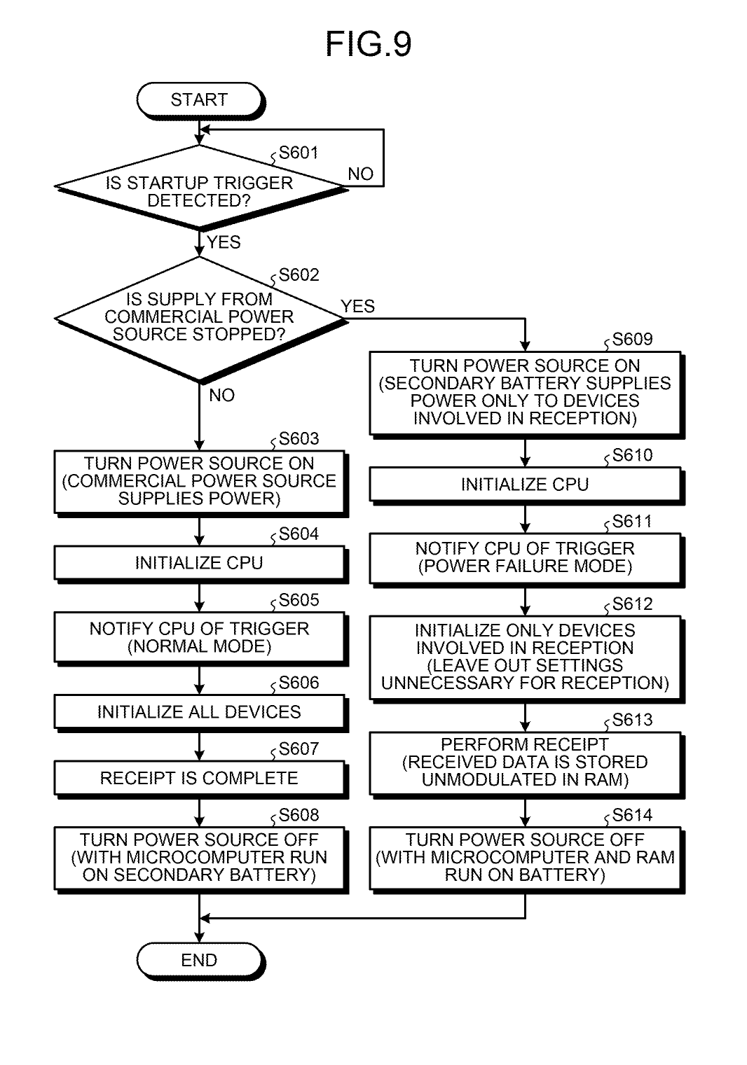

FIG. 9 is a flowchart of a processing sequence according to the third embodiment, a modification of the processing sequence according to the second embodiment illustrated in FIG. 8. Specifically, the processing sequence illustrated in FIG. 9 is obtained by modifying processing at Step S513 of the processing sequence illustrated in FIG. 8 to processing at Step S613. Only Step S613 that differs from the corresponding step of the processing sequence illustrated in FIG. 8 is described below, and description about the other identical steps is omitted.

At Step S613, when image data has been received, the received image data is not modulated by the modem 304 but stored in the RAM 303 as it is, in contrast to processing at Step S513 of the processing sequence illustrated in FIG. 8 (and, accordingly, Step S213 of the processing sequence illustrated in FIG. 5). When this configuration is employed, it is preferable that the image processing apparatus 1 modulates the image data stored in the RAM 303 and stores the modulated image data in the RAM 303 again at recovery from power failure; thereafter, the image processing apparatus 1 forms an image on a recording medium based on the image data stored in the RAM 303 using the image forming unit 5 as an output task that outputs the image data.

With this configuration, the need of supplying electric power to the modem 304 from the secondary battery 307A in the power failure mode is eliminated. Accordingly, because power consumption of the secondary battery 307A in the power failure mode can be reduced, the power failure mode can be maintained for a longer period of time.

A fourth embodiment of the present invention is described below.

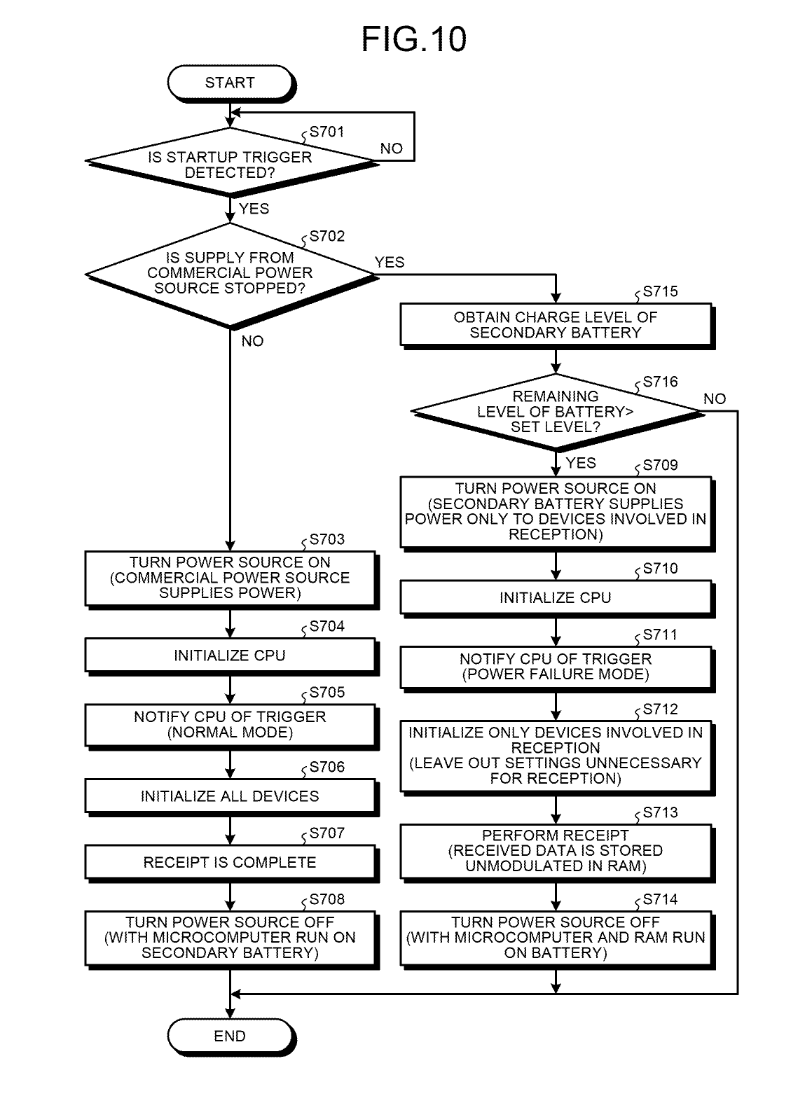

FIG. 10 is a flowchart of a processing sequence according to the fourth embodiment, a modification of the processing sequence according to the third embodiment illustrated in FIG. 9. Specifically, the processing sequence illustrated in FIG. 10 is obtained by adding Steps S715 and S716 between “Yes” option at Step S602 and Step S609 of the processing sequence illustrated in FIG. 9. Put another way, Steps S601 to S608 of the processing sequence illustrated in FIG. 9 correspond to Steps S701 to S708 of the processing sequence illustrated in FIG. 10; Steps S609 to S614 of the processing sequence illustrated in FIG. 9 correspond to Steps S709 to S714 of the processing sequence illustrated in FIG. 10. Only Steps S715 and S716 that differ from the corresponding steps of the processing sequence illustrated in FIG. 9 are described below, and description about the other identical steps is omitted.

Specifically, when the apparatus is determined to be in the power failure state at Step S702 (Yes at Step S702), the power-supply control unit 309 detects a remaining power level of the secondary battery 307A (Step S715). Subsequently, the FCU 3 determines whether the remaining power level of the secondary battery 307A detected at Step S715 is equal to or higher than a preset value (Step S716). When the remaining power level of the secondary battery 307A is determined to be equal to or higher than the preset value (Yes at Step S716), the image processing apparatus 1 proceeds to Step S709.

On the other hand, when the remaining power level of the secondary battery 307A is determined to be lower than the preset value (No at Step S716), the image processing apparatus 1 completes this sequence without performing the fax receiving operation or, put another way, the image-data receiving operation.

With this configuration, an undesirable situation that, for example, the secondary battery 307A becomes exhausted during a fax receiving operation, resulting in loss of received image data can be prevented.

According to the embodiments described above, the fax communication operation can be performed on electric power supplied from the secondary battery 307A in a case of unexpected power cutoff caused by power failure, wire breakage, or the like. Accordingly, it becomes possible to perform the fax communication operation during power failure while the main power supply is cut off by utilizing the storage battery unit (the secondary power source), which is relatively small and already included in the image processing apparatus as a power source for backing up image data stored in the storage unit such as the RAM, without adding a relatively-large storage battery unit such as an UPS. As a result, an effect that an increase in manufacturing cost is avoided is obtained.

Note that preferred embodiments of the present invention include but not limited to the exemplary embodiments described above.

For example, in the embodiments described above, the present invention is applied to an MFP. However, application of the present invention is not limited thereto, but applicable to any other image processing apparatus having at least a function, such as a facsimile function, of transmitting/receiving image data.

In the embodiments described above, the image processing apparatus 1 includes the image forming unit 5, but not limited thereto. The present invention is applicable to an image processing apparatus that includes an output unit that displays received image data on a display device, an output unit that transmits received image data to an external device such as a personal computer, or the like.

In the embodiments, the configuration in which electric power is consistently supplied to the RAM 303 in the power failure mode; this is because received image data is stored in the RAM 303 which is a volatile memory. However, applicable configuration is not limited thereto, and the present invention is applicable to a configuration in which a nonvolatile memory is provided in place of the RAM 303, received image data is stored in the nonvolatile memory, and power supply to the nonvolatile memory is switched off in the power failure mode.

The program instructions for execution by the CPU of the embodiments can be provided as being stored in a storage unit, such as the ROM, of the image processing apparatus 1 in advance. The program instructions may be implemented in a computer program product embodied on a non-transitory tangible computer-readable storage medium stored therein the program instructions as file(s) in an installable or executable format. The program instructions can be provided or distributed over a network such as the Internet.

According to the embodiments, there is obtained an effect that an image-data communication operation can be performed during power failure using a storage battery unit, which is relatively small and already included in an image processing apparatus, without adding a relatively-large storage battery unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a communication unit configured to transmit and receive image data;
an output unit configured to output the image data received by the communication unit;
a storage battery unit used as a power source to back up the image data stored in a storage unit;
a detecting unit configured to detect whether power supply from a main power source from to the image processing apparatus is cut off; and
a power-supply control unit configured to perform a control operation that supplies electric power to the communication unit from the storage battery unit in a cutoff state where the detecting unit detects that the power supply from the main power supply is cut off, wherein
the communication unit performs, in the cutoff state, an image-data communication operation that consumes less power than a communication operation in a normal state where the detecting unit detects that the power supply from the main power supply is not cut off.

2. The image processing apparatus according to claim 1, wherein
the communication unit includes a plurality of elements,
in the cutoff state, the power-supply control unit performs a control operation that supplies electric power from the storage battery to a predetermined element to which electric power is to be supplied in the cutoff state, among the plurality of elements, and
the communication unit performs an operation involved in image data reception using the predetermined element that is operable with the electric power supplied from the storage battery unit in the cutoff state.

3. The image processing apparatus according to claim 1, wherein
the power-supply control unit receives a reduced number of types of interrupt startup triggers in the cutoff state, compared with a number of types of interrupt startup triggers acceptable in the normal state.

4. The image processing apparatus according to claim 1, wherein
the communication unit performs a communication operation in which a predetermined task is omitted in the cutoff state, and performs the omitted predetermined task when transition from the cutoff state to the normal state occurs.

5. The image processing apparatus according to claim 1, wherein
when transition from the cutoff state to the normal state occurs, the output unit outputs the image data that is stored in the storage unit in the cutoff state.

6. The image processing apparatus according to claim 1, further comprising
a detecting unit configured to detect a remaining power level of the storage battery unit, wherein
when the remaining power level of the storage battery unit detected by the detecting unit in the cutoff state is lower than a preset value, the communication unit disables the image-data communication operation.

7. The image processing apparatus according to claim 1, wherein
in the cutoff state, the communication unit performs a communication operation in which a predetermined initialization task is omitted.

8. A communication control method performed in an image processing apparatus that includes a communication unit configured to transmit and receive image data, an output unit configured to output the image data received by the communication unit, a storage battery unit used as a power source to back up the image data stored in a storage unit, a detecting unit configured to detect whether power supply from a main power source from to the image processing apparatus is cut off, and a power-supply control unit configured to perform a control operation that supplies electric power to the communication unit from the storage battery unit in a cutoff state where the detecting unit detects that the power supply from the main power supply is cut off, the communication control method comprising:
performing, by the communication unit performs, in the cutoff state, an image-data communication operation that consumes less power than a communication operation in a normal state where the detecting unit detects that the power supply from the main power supply is not cut off.
